(19) United States
(12) Patent Application Publication
(10) Pub. No.: US 2026/0112207 A1
(43) Pub. Date: Apr. 23, 2026

(54) SYSTEM AND METHOD FOR INFRASTRUCTURE ACCESS MANAGEMENT

(71) Applicant: Cybernet Systems Corporation, Ann Arbor, MI (US)

(72) Inventors: Charles J. Cohen, Ann Arbor, MI (US); Glenn J. Beach, Grass Lake, MI (US); Charles Jacobus, Ann Arbor, MI (US)

(21) Appl. No.: 18/919,989

(22) Filed: Oct. 18, 2024

(51) Int. Cl. G07B 15/06; B60W 60/00

(52) U.S. Cl. CPC G07B 15/063; B60W 30/18163; B60W 2556/45

(57) ABSTRACT

As system including a control module configured to at least partially autonomously control a vehicle, at least one transmitter configured to transmit an infrastructure access request from the vehicle, and at least one receiver configured to receive a first response to the infrastructure access request. The system also includes at least a path monitoring module and a messaging module. The path monitoring module compares a current location of the vehicle and a future path of the vehicle to infrastructure locations. The messaging module initiates transmission of the infrastructure access request, receives the first response, identifies when further information is required to resolve the infrastructure access request, sends the further information when required, and determines whether the infrastructure access request has been granted.

### TECHNICAL FIELD

The present disclosure generally relates to an infrastructure access systems and methods.

### BACKGROUND

New or modified infrastructure may be needed to support electric vehicles and autonomous and semi-autonomous vehicles, whether they are electric driven or combustion driven. For example, distributed fast charging stations, new servicing models (due to the new vehicle technologies), and new roadside services like mobile roadside recharging vehicles may be needed.

These new infrastructures may require society and the user base to support the investment needed to put them in place and to maintain them. Government investment through, for example, taxation, may be employed to support these new infrastructures. Further, user fees or “tolls”may be implemented to support such changes and maintenance.

In the internal combustion era, highway infrastructure is often supported by tolls, user fees (tax) imposed on gasoline or other fuels, and general fund taxes. Each of these funding mechanisms, however, may change or be altered with the advent electric vehicles and autonomous and semi-autonomous vehicles. For example, with regard to electric vehicles, implementing a fuel tax to serve as a proxy for a use tax can be difficult. Often electric vehicle are charged at a user's residence. In such situations, it can be difficult to come up with a scheme that taxes the electricity used to charge a vehicle while ensuring that electricity used for the residence is not taxed.

Therefore, a system and method for associating infrastructure costs with autonomy infrastructure use is needed.

### BRIEF DESCRIPTION OF THE DRAWINGS

FIG. 1 illustrates a scene representing a vehicle operating with an exemplary infrastructure access system;

FIG. 2A is a block diagram of an exemplary vehicle architecture having an exemplary infrastructure access module incorporated therein;

FIG. 2B is a block diagram of the exemplary infrastructure access module of FIG. 2A; and

FIG. 3 illustrates an exemplary technique for infrastructure access management.

### DETAILED DESCRIPTION

Referring to the discussion that follows and the Figures, illustrative approaches to the disclosed systems and methods are described in detail. Although the Figures represent some possible approaches, the Figures are not necessarily to scale and certain features may be exaggerated, removed, or partially sectioned to better illustrate and explain the present disclosure. Further, the descriptions set forth herein are not intended to be exhaustive, otherwise limit, or restrict the claims to the precise forms and configurations shown in the Figures and disclosed in the following detailed description.

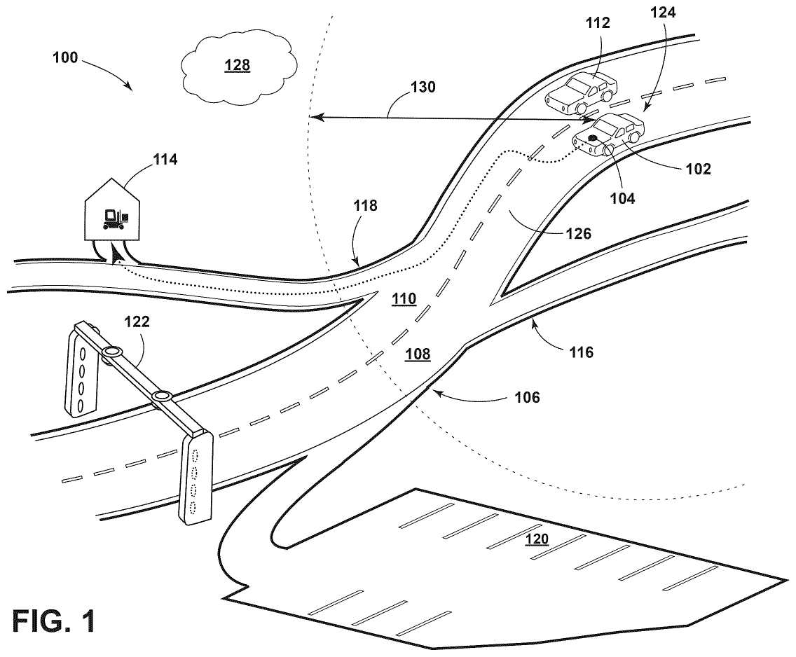

With reference to FIG. 1, a scene 100 representing a first vehicle 102 operating with an exemplary infrastructure access system 104 is shown. The scene 100 represents the vehicle 102 driving down a multi-lane roadway 106 (e.g., an interstate highway) having two lanes 108, 110. Also shown is a different vehicle 112 (i.e., a second vehicle).

Along the highway 106 are a plurality of infrastructure locations that includes the multi-lane roadway 106 and its lanes 108, 110, a load drop-off or pickup location 114 (e.g., a warehouse or other business facility), an onramp 116, an offramp 118, a stopping location 120 (e.g., a parking spot), and a tollway 122. The infrastructure locations 106-110, 114-122 shown are merely exemplary. Effectively, an infrastructure location may be any location or region that requires access rights.

The infrastructure access system 104 is configured to identify the infrastructure locations 106-110, 114-122 that are by its current location 124 and along its path or future path 126 of travel. When needed, the infrastructure access system 104 requests access from a management system 128 to one or more of the locations 106-110, 114-122. A management system 128 is any communication system responsible for granting or denying access to any of the infrastructure locations 106-110, 114-122. The management system 128 may manage one or more of the infrastructure locations 106-110, 114-122. While only one managements system 128 is shown in FIG. 1, other examples may include multiple management systems, where each additional management system is associated with one or more infrastructure locations.

A management system, such as the management system 128 of FIG. 1, may be remote from its respective infrastructure locations 106-110, 114-122. Alternatively, the management system may be in the proximity of one or more of the infrastructure locations 106-110, 114-122.

The infrastructure access system 104 may communicate with the management system 128 via cellular signal, wi-fi, satellite, radio, or another type of wireless communication system.

To serve as an example of how the infrastructure access system 104 operates, let the management system 128 be the management system of the second vehicle 112. While not shown, the management system 128 in this example may be incorporated into the second vehicle 112. The infrastructure access system 104 of the first vehicle 102 may send an infrastructure access request to the management system 128 of the second vehicle 112 to request access to the second lane 110 of the roadway 106. In addition to requesting access, the infrastructure access request may, or may not, also include identifying information (e.g., driver identification, vehicle identification, and/or payment information).

The management system 128 may, for example, grant the first vehicle 102 access to the second lane 110. As such, the second vehicle 112 may, for example, yield to the first vehicle 102 so the first vehicle 102 may move from the first lane 108 to the second lane 110. Such action could be carried out autonomously if the first and second vehicles 102, 112 are autonomous vehicles.

To serve as another example, let the management system 128 be the management system for the load drop-off or pickup location 114 of a business. The infrastructure access system 104 of vehicle 102 (e.g., a semi-trailer) may request access from the management system 128 associated with the load drop-off or pickup location 114.

Communications between the infrastructure access system 104 and the management system 128 may happen directly or through intermediaries. For example, if the infrastructure access system 104 is not within range of the management system 128 (i.e., unable to communicate with the management system 128 for whatever reason), the infrastructure access system 104 may be configured to communicate with other vehicle(s) (intermediaries) in order to convey the request(s) to the management system 128. In other words, when infrastructure access system 104 is not within range of the management system 128, or otherwise unable to communicate with the management system 128, the infrastructure access system 104 may be configured to convey the request to another vehicle (e.g., the second vehicle 112) within range of the management system 128, which in turn would convey the request to the management system 128. Indeed, a plurality of other vehicles could be employed as repeaters (intermediaries) for conveying the request(s). Similarly, replies from the management system 128 could be conveyed to the first vehicle 102 directly or via other vehicle(s) when the first vehicle 102 and its infrastructure access system 104 is not within range of the management system 128.

Regardless of how the access requests are provided and responses received, if the request is granted by the management system 128, the vehicle 102 may continue its journey to the location 114. If it is not granted, however, the vehicle 102 may change course.

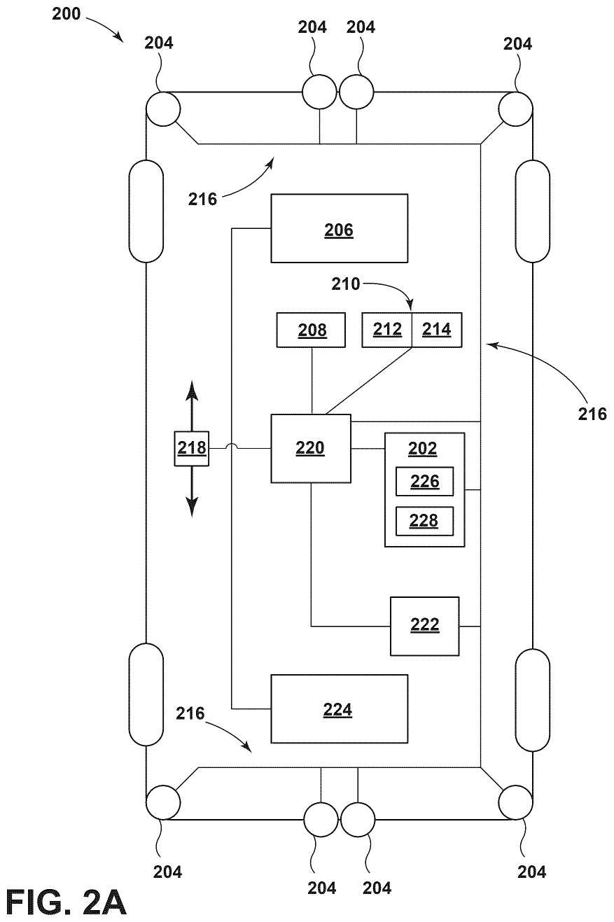

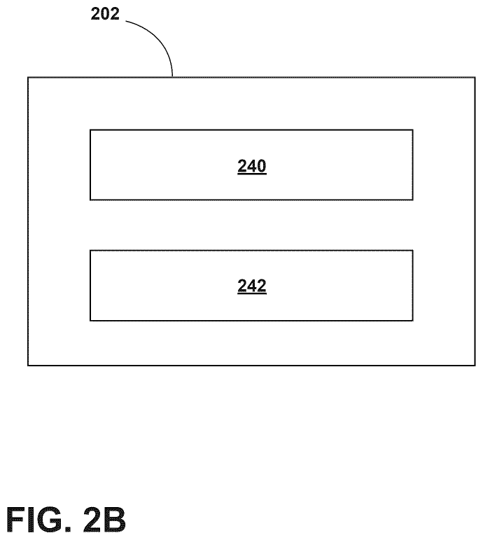

Further details are provided below with respect to FIGS. 2A-2B, but whether or not access is granted to an infrastructure location may be dependent on a variety of factors. For example, the management system 128 could ask the infrastructure access system 104 of the first vehicle 102 for driver credentials (e.g., vehicle indemnification number (VIN) and/or driver's license number) before granting access to the pickup or drop-off location 114. If, for example, the credentials do not match credentials in a database, access to the pickup or drop-off location 114 may be denied. In addition, or alternatively, payment may be required to gain access to the infrastructure location. The amount of payment required, could, for example, be based on a flat fee (e.g., a flat fee to enter a turnpike) and/or based on a distance traveled (e.g., a fee to travel “x” miles in a fast lane).

Estimated arrival time of the first vehicle 102 could also serve as a factor for determining whether or not access to the infrastructure location is granted. For example, in order to avoid bottlenecks, the management system 128 may need an estimated arrival time of the first vehicle 102. If the management system 128 determines that, based on the estimated arrival time of the vehicle 102, a “bottleneck” could occur with other vehicles, the management server 128 could notify the infrastructure access system 104 that access is denied, but it may be granted for a different arrival time.

In an example, the infrastructure access system 104 may be configured to provide an infrastructure access request only when the vehicle 102 is within a present proximity distance 130 of the relevant infrastructure location. For example, when the first vehicle 102 of FIG. 1 comes within the preset proximity distance 130 (defined, e.g., by a radius emanating from the vehicle 102) to the load drop-off and pickup location 114, its infrastructure access system 104 may provide an infrastructure access request to the management system 128 of the location 114. Accordingly, in some instances, requests may only be sent when the vehicle 102 is within the proximity of the location.

The preset proximity distance 130 shown in FIG. 1 is merely exemplary. Further, the preset proximity distance 130 may be configurable by the driver of the vehicle 102 or some other person or entity.

As represented in the scene 100 of FIG. 1, the infrastructure access system 104 of the first vehicle 102 identifies infrastructure location(s) 106-110, 114-122 and manages communications with one or more management systems 128 responsible for managing access to the respective location 106-110, 114-122.

Among other things, the infrastructure access system 104 may also be responsible for providing payment via a management system (e.g., the management system 128 of FIG. 1) to gain access to infrastructure locations (e.g., the infrastructure locations 106-110, 114-122 of FIG. 1).

While vehicles (e.g., cars and semi-trailer trucks) are discussed herein, the systems (e.g., the infrastructure access system 104 and the management system 128) can be implemented with a variety of transportation devices. For example, powered or manually powered bicycles, motorcycles, buses, and/or boats (to name a few) could employ the infrastructure access system discussed above and below.

Further, while the infrastructure access systems and the management systems discussed above and below are employed for granting and denying access to infrastructure locations, they also may be employed for other purposes. For example, a vehicle owner, or one responsible for the vehicle, could report a vehicle stolen. This information could be conveyed to management system(s) and/or the infrastructure access system of the vehicle. Via the interaction between the infrastructure access system and the management system(s), the vehicle could be tracked or even caused to come to a safe stop.

Referring now to FIG. 2A, a block diagram of an exemplary vehicle 200 having an exemplary infrastructure access system or infrastructure access module or infrastructure accessor (hereinafter “infrastructure access module”) 202 incorporated therein is shown. Among other things which will be described in further detail below, the exemplary infrastructure access module 202 controls messaging associated with infrastructure access requests. The infrastructure access request requests access to various infrastructure (e.g., one or more of the infrastructure locations 106-110, 114-122 of FIG. 1). For example, the infrastructure access request may request access to a vehicle stopping location for the vehicle (e.g., a parking spot or other stopping location), a road lane on a multi-lane roadway, an entrance to a toll road, entrance onto an onramp or and offramp, and/or a load pickup or drop off location.

The vehicle 200 of FIG. 2A may also include a plurality of sensors 204 for tracking vehicle location and/or obstacle detection. While eight sensors 204 are shown, other examples may include less than eight or more than eight sensors 204.

The sensors 204 may include, for example, some combination of video, range, inertial measurement units (IMUs), and/or inertial navigation sensors (INSs). Further, such sensors 204 may include, for example, light detection and ranging (LIDAR) sensors, radar sensors, global positioning system (GPS) sensors, and/or 3D stereo wide sensors to name a few. Any sensor that gathers details about the environment in which the vehicle 200 operates is contemplated. It is noted that sensor data may or may not be processed by hardware, software, artificial intelligence, and/or etc. prior to being conveyed to its destination.

The vehicle 200 may also include a steering control module or steering controller 206, dashboard host control interface (HCl) 208, and one or more vehicle to vehicle (V2V), vehicle to infrastructure (V2I), and/or vehicle to pedestrian (V2P) transceivers 210. The transceiver(s) 210 include a transmitter 212 and a receiver 214. In other examples, separate transmitter(s) and receiver(s) may be employed instead or, or in addition to, the transceivers 210.

Next, the vehicle 200 may also include a sensor bus 216, a controller area network (CAN) bus 218, and a control module or controller (hereinafter “control module”) 220. If the vehicle 200 is an autonomous vehicle (AV), the control module 220 may then be an AV controller. Alternatively, if the vehicle 200 is a manual vehicle (MV), the control module 220 could be a MV controller, which may have assistive drive system capabilities. The vehicle control module 220 at least partially controls the vehicle 200. If the vehicle 200 is an AV, this may include controlling, at least sometimes, all movement (e.g., acceleration, deceleration, turning, and etc.) of the vehicle 200. If, on the other hand, the vehicle 200 is an MV, the vehicle control module 220 may operate as an assistive drive system controlling, for example, cruise control and braking an acceleration in some instances.

The control module 220 is in communication with the infrastructure access module 202, as well as the sensors 204 via the sensor bus 216. Further, the control module 220 is communicatively coupled to the CAN bus 218, which in turn is in communication with microcontrollers and/or other devices for controlling the vehicle. Still further, the control module 220 may be communicatively coupled to a vehicle location module or vehicle locator (hereinafter “vehicle location module”) 222.

Also shown in the vehicle 200 is a speed, brake, acceleration, and transmission control system 224, which is also in communication with the control module 220.

Among other things, the exemplary infrastructure access module 202 may be communicatively coupled to the control module 220, the sensors 204, and the vehicle location module 222.

The infrastructure access module 202 may include, for example, a path monitoring module or path monitor (hereinafter “path monitoring module”) 226 in communication with a messaging module or messenger (hereinafter “messaging module”) 228.

The path monitoring module 226 compares the location of the vehicle (received via, for example, the vehicle location module 222) and a future path of the vehicle (e.g., the path 126 shown in FIG. 1) to infrastructure locations at the vehicle location and along the future path of the vehicle. In other words, the path monitoring module 226 of FIG. 2A identifies infrastructure locations along the path to the vehicle's destination and locations associated with the vehicle's current location. Exemplary infrastructure locations include, for example, vehicle stopping locations, road lane locations on a roadway, toll road locations, onramp or and offramp location, and/or a load pickup or drop-off locations.

The messaging module 228 of the infrastructure access module 202 controls messaging associated with one or more of the infrastructure locations. For example, when needed, the messaging module 228 may send (via, e.g., the transmitter 212 of transceiver 210) an infrastructure access request to a management system (e.g., the management system 128 of FIG. 1) responsible for access management of the relevant infrastructure location. As mentioned above, the infrastructure access request requests access to infrastructure locations such as, for example, vehicle stopping locations, road lanes on a multi-lane roadway, entrance to a toll road, load pickup or drop-off locations, onramps, and/or offramps.

After sending the request(s), the messaging module 228 of FIG. 2A receives (via, e.g., a receiver 214 of the transceiver 210) a first response to the infrastructure access request from the management system.

After receiving the first response, the messaging module 228 may then, based on the first response, determine whether access to the infrastructure location is granted. For example, the first response may inform the messaging module 222 that access to a lane on a multi-lane highway is granted, that the vehicle is granted access to an onramp or offramp to respectively enter or leave a highway, the vehicle is granted access to a stopping location (e.g., a parking spot or a waiting lot at an airport), or the vehicle is granted access to load pickup or drop-off location.

Alternatively, based on the first response, the messaging module 228 may determine that further information is required to gain access to the infrastructure location or region. For example, the further information may include a request for payment information (e.g., a toll payment), vehicle identification information (e.g., a vehicle identification number (VIN)), a driver identification information (e.g., driver name or social security number), and/or license to operate information.

Other types of “further information”are contemplated.

If further information is required, the messaging module 228 may send (via, e.g., the transmitter 212 of FIG. 1) the further information (e.g., the payment information, vehicle identification information, and/or driver identification information). Next, in response to the further information sent, the messaging module 228 may receive a second response from the management system. This second response may grant or deny access to the infrastructure in which access was requested. In other words, infrastructure access may be granted or denied based on the further information sent.

While in the example above the “further information” was sent after the infrastructure access request, in other examples, some or all of the further information may be incorporated into the infrastructure access request. In other words, information such as payment information, driver identification information, and/or vehicle identification information may be sent with the infrastructure access request.

Regardless with how and when further information is sent, the messaging module 228 may then communicate, directly or indirectly, with the control module 220. For example, if access is granted to a parking spot and the vehicle is an AV, the messaging module 228 may initiate the control module 220 to cause the vehicle to drive to, and park in, the parking spot. As another example, if the vehicle is a MV and a request to use a different lane on a highway is not granted, the control module 220 may employ its assistive driving capabilities to not allow the driver to move into that different lane.

With reference now to FIG. 2B, a block diagram of the exemplary infrastructure access module 202 of FIG. 2A is shown. The infrastructure messaging module 202 may be comprised of a software stack and/or one or more hardware modules. As such, the infrastructure access module 202 may include one or more processors 240 and one or more memory components 242. Instructions to make the exemplary infrastructure access module 202 operable may be stored on the one or more memory components 242 (e.g., non-transitory storage medium such as solid-state drive(s), hard disk drive(s) (HDD), flash, or other memory). Additionally, or alternatively, some or all the instructions may be incorporated in the one or more processors 240.

Regardless of how the instructions are implemented, the processors(s) 240 and/or memory 242 may be employed to carry out the actions of the infrastructure access module 202, along with its path monitoring module 226 (see FIG. 2A) and messaging module 228 (see FIG. 2A).

By employing the infrastructure access module 202, fees can be transferred from those responsible for the vehicle 200 (FIG. 2A), or renting, leasing, or borrowing the vehicle, to those responsible for infrastructure locations. Further, the infrastructure access module 202 enables these fees (payments) to be tied to use. In other words, the infrastructure access module 202 provides a pathway to tie the use of autonomy (or semi-autonomy) infrastructure to its costs.

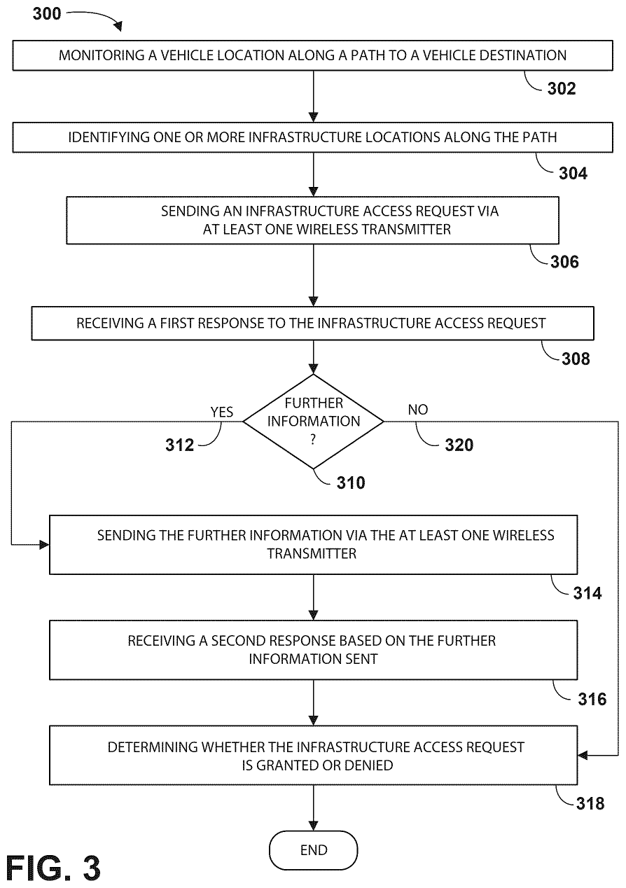

Referring now to FIG. 3, a technique 300 for infrastructure access determinations is shown. This technique 300, and any instruction associated therewith, may be incorporated into one or more processors (e.g., the processor(s) 240 of FIG. 2B) and/or one or more memory units (e.g., the memory unit(s) 242 of FIG. 2B).

Process control begins at block 302 of FIG. 3, where monitoring a vehicle location along a path to a vehicle destination is carried out. A vehicle location module (e.g., the path monitoring module 226 module of FIG. 2A) may be employed to monitor the vehicle location along its path to its destination. Alternatively a sensor (e.g., one or more of the sensors 204 of FIG. 2A) having GPS capabilities, or the like, could be employed to monitor the vehicle location along its path to the vehicle destination.

Still referring to FIG. 3, while the vehicle location along its path is being monitored, process control proceeds to block 304, where identifying, via at least one processor, one or more infrastructure locations along the path is carried out. A path monitoring module (e.g., the path monitoring module 226 of FIG. 2A) may, for example, carry out this task. The path monitoring module may have access to a database that includes infrastructure locations. By comparing the infrastructure locations to the vehicle's current location and its intended path, infrastructure at or near the vehicle's current location and at or near the vehicle's intended path can be identified.

After identifying one or more infrastructure locations, process control proceeds to block 306 of FIG. 3, where sending an infrastructure access request via a wireless transmitter (e.g., the transmitter 212 of FIG. 2A) is carried out. The infrastructure access request requests access to, for example, a vehicle stopping location for the vehicle, a road lane on a multi-lane roadway, an entrance to a toll road, onramp and offramp access, and/or load pickup or drop off location(s). This request may, for example, be sent by a vehicle messaging module (e.g., the messaging module 228 of FIG. 2A).

The sending of the infrastructure access request may be based on the vehicle location and/or the vehicle's intended path to the destination. For example, a vehicle location could be at or near a parking spot (i.e., an infrastructure feature). In other words, the vehicle could be at or within a preset proximity distance from the infrastructure feature or location. As such, based on the vehicle's location, an infrastructure access request requesting access to the parking spot could be sent. Similarly, and to serve as another example, an AV could be traveling down a multi-lane highway and send an infrastructure access request requesting access to a lane the AV is not currently driving in. As yet another example, the vehicle could be a delivery vehicle at a gate to enter a business lot. Based on the vehicle's location relative to the gate or business, an infrastructure access request requesting access to the lot could be sent. That is, a request to allow access to the lot or a load drop-off or pickup location could be sent when the vehicle is at, or within, a preset proximity distance to the lot or business.

A path monitoring module (e.g., the path monitoring module 226 of FIG. 2A) could be employed with the messaging module to carry out these tasks. For example, a messaging module may rely on the path monitoring module to determine if the vehicle is at or within the preset proximity distance (see, e.g., the preset proximity distance 130 of FIG. 1) to a particular infrastructure region or feature. If the vehicle is at or within the preset proximity distance, the messaging module may send out the infrastructure access request to whichever management system is managing that particular infrastructure.

After sending the infrastructure access request, process control proceeds to block 308 of FIG. 3, where receiving a first response to the infrastructure access request is carried out. The vehicle may wirelessly receive the response via, for example, a receiver (e.g., the receiver 212 of FIG. 2A). This response could, for example, be sent by whichever management system (e.g., the management system 126 of FIG. 1) is managing that particular infrastructure.

Upon receiving the first response, process control proceeds to block 310 of FIG. 3, where identifying whether further information is required to resolve the infrastructure access request occurs. For example, the first response may include data that indicates further information is needed. This “further information” may include, for example, payment information, vehicle identification information, and/or driver identification information. Other further information is contemplated. A messaging module (e.g., the messaging module 228 of FIG. 2A) may be employed to determine from the first response whether further information is needed.

Still referring to FIG. 3, if further information is needed 312, process control proceeds to block 314, where sending the further information via at least one wireless transmitter occurs. In other words, once it is determined further information is needed, the system sends the further information via its messaging module. The determination of whether or not to send further information may be based on the first response. As mentioned above, the first response may include data that indicates that further information is needed before the infrastructure access request can be processed or resolved.

In an example where the further information sent at block 314 is payment information, the technique 300 allows for an effective manner of tying the cost of infrastructure to the use of infrastructure.

As an alternative to the technique 300 of FIG. 3, another technique may incorporate the further information into the initial infrastructure access request. That is, the further information may instead be sent when initially sending the infrastructure access request. For example, it may be known ahead of time that some infrastructure requires further information. As such, based on the vehicle location, infrastructure proximity, and/or some other infrastructure identifier, the messaging module may send the further information (e.g., payment information, vehicle identification information, and/or driver identification information) with the initial infrastructure access request. As such, there may be no need to determine whether further information is needed.

Nonetheless, referring back to the technique 300 of FIG. 3, after sending the further information at block 314, process control proceeds to block 316 and receiving a second response based on the further information sent occurs. This second response (received via, e.g., the receiver 214 of FIG. 2A) includes data indicating whether the further information is acceptable, thus indicating whether infrastructure access has been granted or denied. As such, after receiving the second response, process control proceeds to block 318 of FIG. 3 for determining whether access has been granted or denied based on the second response. A messaging module of the vehicle may be employed to determine whether the second response indicates whether the access has been granted or denied.

As discussed above, further information may be needed 312 to determine if an infrastructure access request is granted or denied. In some instances, however, further information may not be required 320. In such an instances, the determination of whether or not to grant access may be based on the first response received at block 308. As such, process control may proceed to block 318 to make the access determination after the first response is received at block 308. For example, the first response received at block 308 may simply indicate that the access request was granted or denied. Accordingly, the access determination made at block 318 may be based on the first response received at block 308.

If it is determined that infrastructure access is granted, whether it is based on the first and/or second response, the vehicle may then access the requested infrastructure. If the vehicle is an AV or an MV with assistive driving capabilities (i.e., semi-autonomous driving capabilities), the information associated with the response may be provided to a vehicle control system (e.g., the control module 220 of FIG. 2A), which may then determine the vehicle's upcoming actions.

After making the access determination at block 318, the technique 300 may come to an end.

With regard to the processes, techniques, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain examples, and should in no way be construed so as to limit the claims.

Aspects of the present disclosure are described herein with reference to flowchart illustrations and/or block diagrams of methods, apparatuses (systems), computer program(s), software, and/or artificial intelligence (AI) products according to embodiments of the disclosure. It will be understood that each block of the flowchart illustrations and/or block diagrams, and combinations of blocks in the flowchart illustrations and/or block diagrams, can be implemented via instructions of computer program(s), software, and/or AI. These instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The non-transitory computer-readable media includes all types of computer-readable media, including, but not limited to, magnetic storage media, optical storage media, and solid-state storage media, though it specifically excludes signals. It should be understood that the instructions can be installed in and sold with the device. Alternatively, the instructions can be obtained and loaded into the device via a disc medium or from any manner of network or distribution system (e.g., a wireless system), including, for example, from a server owned by the creator or from a server not owned but used by the creator. The instructions can be stored on a server for distribution over the Internet, for example.

Computer-readable storage media (medium) exclude (excludes) propagated signals per se, can be accessed by a computer and/or processor(s), and include volatile and non-volatile internal and/or external media that is removable and/or non-removable. For the computer, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

Further, when introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Next, any numerical examples in the following discussion are intended to be non-limiting, and thus additional numerical values, ranges, and percentages are within the scope of the disclosed embodiments. Still further, the use of terms such as “first,” “second,” “third,” and the like that immediately precede an element(s) do not necessarily indicate sequence unless set forth otherwise, either explicitly or inferred through context. Rather, these terms may simply be used as distinguishing indicators.

While the preceding discussion is generally provided in the context of a material used in connection with vehicles, it should be appreciated that the present techniques are not limited to such limited contexts. The provision of examples and explanations in such a context is to facilitate explanation by providing instances of implementations and applications. The disclosed approaches may also be utilized in other contexts or configurations, such as the context of other systems that employ an internal combustion engine that may not be a vehicle.

While the disclosed materials have been described in detail in connection with only a limited number of embodiments, it should be readily understood that the embodiments are not limited to such disclosed embodiments. Rather, that disclosed can be modified to incorporate any number of variations, alterations, substitutions or equivalent arrangements not heretofore described, but which are commensurate with the spirit and scope of the disclosed materials. Additionally, while various embodiments have been described, it is to be understood that disclosed aspects may include only some of the described embodiments. Accordingly, that disclosed is not to be seen as limited by the foregoing description, but is only limited by the scope of the appended claims.

What is claimed is:

1. As system comprising:
a control module configured to at least partially autonomously control a vehicle;
at least one transmitter configured to wirelessly transmit an infrastructure access request from the vehicle, wherein the infrastructure access request requests access to at least one of a vehicle stopping location for the vehicle, a road lane on a multi-lane roadway, an entrance to a toll road, a load pickup or drop off location, and an onramp or offramp location;
at least one receiver configured to wirelessly receive, at the vehicle, a first response to the infrastructure access request;
a path monitoring module having at least one processor and in communication with the at least one transmitter and the at least one receiver, the path monitoring module configured to compare a current location of the vehicle and a future path of the vehicle to i) infrastructure locations by the current location and ii) infrastructure locations along the future path, wherein the infrastructure locations include at least one of the vehicle stopping location for the vehicle, the road lane on the multi-lane roadway, the entrance to the toll road, the load pickup or drop-off location, and the onramp or offramp location; and
a messaging module in communication with the path monitoring module, the messaging module configured to:
initiate a transmission of the infrastructure access request;
receive, from the at least one receiver, the first response to the infrastructure access request;
identify when further information is required to resolve the infrastructure access request, wherein the further information includes at least one of payment information, vehicle identification information, and driver identification information;
send, via the at least one transmitter; the further information when required; and
determine whether the infrastructure access request has been granted.

2. The system of claim 1 wherein the messaging module is further configured to communicate with at least one management system, and wherein the at least one management system allows or denies the infrastructure access request, and wherein the messaging module initiates the transmission of the infrastructure access request based on a vehicle proximity distance to one of the infrastructure locations.

3. The system of claim 2 wherein the management system is associated with a different vehicle, and wherein the infrastructure access request requests access to the road lane on the multi-lane roadway, and wherein the different vehicle is in the road lane on the multi-lane roadway.

4. The system of claim 2 wherein the identification of whether further information is required to resolve the infrastructure access request is based on the first response.

5. The system of claim 2 wherein the control module at least partially controls the vehicle based on the first response, wherein the infrastructure management system allows or denies the infrastructure access request via the first response.

6. The system of claim 2 wherein the infrastructure access request requests access the stopping location and the further information is the payment information.

7. The system of claim 4 wherein the messaging module is further configured to receive a second response via the at least one receiver, the second response is based at least in part on the further information sent via the messaging module, and wherein the control module at least partially controls the vehicle based on the second response, and wherein the infrastructure management system allows or denies the infrastructure access request via the second response.

8. An apparatus comprising:
at least one non-transitory computer readable storage medium couplable to a vehicle, the at least one computer readable storage medium having instructions stored thereon to:
at least partially autonomously control a vehicle;
determine a current vehicle location of the vehicle and a future path of the vehicle to a destination;
identify infrastructure locations by the current vehicle location and along the future path, wherein a first infrastructure location of the infrastructure locations includes at least one of a vehicle stopping location, a road lane location on a roadway, a toll road location, a load pickup or drop off location, and an onramp or offramp location;
initiate transmission, via at least one transmitter, of an infrastructure access request to a management system responsible for granting access to one of the first infrastructure location;
receive, via at least one receiver, a first response to the infrastructure access request from the management system;
identify when further information is required to resolve the infrastructure access request, wherein the further information includes at least one of payment information, vehicle identification information, and driver identification information;
send, via the at least one transmitter, the further information to the management system when required; and
determine whether the infrastructure access request has been granted by the management system.

9. The apparatus of claim 8 and wherein the at least partial autonomous control of the vehicle is based on the determination of whether the infrastructure access request has been granted by the management system.

10. The apparatus of claim 8 wherein the infrastructure access request requests access to the stopping location and the further information is the payment information.

11. The apparatus of claim 8 wherein the management system is associated with a different vehicle, and wherein the first infrastructure location is the road lane location on the roadway, and wherein the different vehicle is in the road lane on the roadway.

12. The apparatus of claim 8 wherein the initiation of the transmission of the infrastructure access request is based on a preset proximity distance of the vehicle from the first infrastructure location.

13. The apparatus of claim 12 wherein the identification of whether further information is required to resolve the infrastructure access request is based on the first response.

14. The apparatus of claim 13, the at least one non-transitory computer readable storage medium having further instructions to receive a second response from the management system via the at least one receiver if the further information is sent, wherein the determination of whether the infrastructure request has been granted is based on the second response.

15. A method comprising:
monitoring a vehicle location along a path to a vehicle destination;
identifying, via at least one processor, a plurality of infrastructure locations along the path, wherein a first infrastructure location of the plurality of infrastructure locations includes at least one of a vehicle stopping location for the vehicle, a road lane on a multi-lane roadway, an entrance to a toll road, a load pickup or drop off location, and an onramp or offramp location;
sending, based on the vehicle location and the path, an infrastructure access request, wherein the infrastructure access request requests access from a management system responsible for managing access to the first infrastructure location, and wherein sending the infrastructure access request occurs via at least one wireless transmitter;
receiving a first response to the infrastructure access request from the management system;
identifying when further information is required to resolve the infrastructure access request, wherein the further information includes at least one of payment information, vehicle identification information, and driver identification information;
sending the further information via the at least one wireless transmitter when the further information is required to resolve the infrastructure access request; and
determining whether the infrastructure access request was denied or granted by the management system.

16. The method of claim 15 wherein the management system is associated with a different vehicle, and wherein the infrastructure access request requests access to the road lane on the multi-lane roadway, and wherein the different vehicle is in the road lane on the multi-lane roadway.

17. The method of claim 15 further comprising determining, based on identifying the plurality of infrastructure locations along the path, when the vehicle is within a preset proximity distance from the first infrastructure location, wherein sending the infrastructure access request is based on the vehicle being within the preset proximity distance.

18. The method of claim 15 wherein the determining whether the infrastructure access request was denied or granted is based on the first response.

19. The method of claim 15 further comprising receiving a second response from the management system after the first response is sent, wherein the determining whether the infrastructure access request was denied or granted is based on the second response.

20. The method of claim 15 wherein the identifying when the further information is required is based on the first response.
